(19) United States
(12) Patent Application Publication
(10) Pub. No.: US 2010/0029157 A1
(43) Pub. Date: Feb. 4, 2010

(54) FABRIC WEB HAVING PHOTOCATALYSIS-BASED POLLUTION CONTROL PROPERTIES

(75) Inventors: Cedric Brochier, Lyon (FR); Delphine Malhomme, Valence (FR); Emmanuel Deflin, Brindas (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: Brochier Technologies, Villeurbanne (FR)

(21) Appl. No.: 12/520,452

(22) PCT Filed: Dec. 20, 2007
(86) PCT No.: PCT/FR07/52594

§ 371 Date: Jun. 19, 2009

(30) Foreign Application Priority Data
Dec. 20, 2006 (FR) 0655665

(51) Int. Cl. B32B 5/02; B32B 27/02; B32B 27/34; B32B 27/32; B32B 27/36; D03D 15/00

(52) U.S. Cl. 442/168; 442/164; 442/59; 442/170; 442/171; 442/187

(57) ABSTRACT

Fabric web comprising warp and/or weft optical fibres woven with warp and weft binding yarns, in which said optical fibres can emit light sideways characterised in that the surface of the binding yarns is provided with photocatalytic particles and in that said optical fibres include invasive alterations, whereby the free ends of said optical fibres can be positioned facing a light source in order to transmit light and emit light sideways at the aforementioned alterations so as to activate the photocatalytic particles.

### CROSS REFERENCE TO RELATED APPLICATIONS

This application is a National Stage filing under 35 U.S.C. §371 of PCT Application No. PCT/FR2007/052594, filed Dec. 20, 2007. This application also claims the benefit of French Application No. 0655665, filed Dec. 20, 2006. The entirety of both applications is incorporated herein by reference.

The invention relates to the field of controlling pollution in fluids such as foul air or waste water. In fact, a pollution-control fabric web can be used in open spaces charged with carbon dioxide or other organic particles suspended in air. It can also be used in a plant for cleansing or treating waste water in order to control pollution in water which flows tangentially relative to the fabric web and/or through interstices in the fabric web at points where the yarns which constitute it intersect.

It relates more especially to a fabric web provided with optical fibres in order to transmit light.

### DESCRIPTION OF THE PRIOR ART

Generally speaking, as described in Document EP-1 008 565, fabric webs which can be used to control pollution in a fluid by means of glass cloths or optical waveguides are laterally illuminated by natural sunlight. In fact, the glass fibres used, according to the information disclosed by this document, make it possible to collect light from the sun and transmit it in order to activate photocatalytic particles which are present in the cloth.

Thus, the first object of the invention is to improve the efficiency of the photocatalytic reaction by using an ancillary light source capable of activating the photocatalytic particles which are placed on the fabric web.

As described in Document EP 0 823 280, using an ancillary light source to illuminate the ends of optical fibres grouped together as a web of interwoven optical fibres is also known. These optical fibres are treated and have invasive alterations such as notches or small slits so that they emit light sideways and activate photocatalytic particles deposited on the outer surface of these fibres.

However, depositing the photocatalytic particles on the surface of the optical fibres and making them adhere is difficult to achieve because of the material of which they are made. Consequently, very few particles can be deposited on each optical fibre. It is therefore necessary to size the web with a large number of optical fibres in order to obtain a satisfactory level of pollution control.

The second object of the invention is therefore to limit the number of optical fibres so as to reduce the manufacturing cost and overall size of a pollution control system.

In addition, the particles can be deposited on the invasive alterations of the optical fibres and reflect light without thereby being activated by coming into contact with the surrounding medium which is to be cleaned up.

Another object of the invention is therefore to position the photocatalytic particles as close as possible to the invasive alterations without thereby impairing the sideways emission of light by the optical fibres.

### SUMMARY OF THE INVENTION

The invention therefore relates to a fabric web comprising warp and/or weft optical fibres woven with warp and weft binding yarns, said optical fibres being capable of emitting light sideways.

The inventive fabric web is characterised in that the surface of the binding yarns is provided with photocatalytic particles and in that the optical fibres include invasive alterations whereby the free ends of said optical fibres can be positioned facing a light source in order to transmit light and emit light sideways at the aforementioned alterations so as to activate the photocatalytic particles.

In other words, the photocatalytic particles are activated by radiation, which can be ultraviolet radiation, from optical fibres capable of guiding and distributing the light within the fabric web. Because the optical fibres are woven with binding yarns, the fabric web that is thus formed is homogeneous and easy to handle in order to attach it to a support or frame. Simply cutting the fabric web to the size of the frame makes it possible to produce pollution control devices having any dimensions.

In addition, the presence of the binding yarns makes it possible to form a filter having a filtration rating which depends directly on the method of weaving the fabric web comprising the binding yarns, not just on the number of optical fibres used. In fact, the fluid to be filtered can flow through this web whilst preventing macro-particles, for instance, from passing through.

In addition, the invasive alterations made in the optical fibres in order to emit light sideways can be made in various ways, especially by sandblasting, chemical etching or fusion by using high-intensity luminous radiation such as laser light. Obviously, such invasive alterations can also be made by using many other mechanical or chemical processes.

The light sources intended to illuminate the free ends of the optical fibres can be of various types, they can, in particular, be in the form of light emitting diodes or wide-area sources such as incandescent lamps, fluorescent tubes or discharge tubes which contain a gas such as neon.

Also, in one particular embodiment, the light source may comprise a collector capable of point-focusing or linearly focusing natural sunlight towards at least one free end of the optical fibre.

Advantageously, the invasive alterations of the optical fibres may be distributed gradually over the surface of the fabric web.

In fact, in order to obtain uniform illumination of the fabric web and hence uniform activation of the photocatalytic particles which are evenly distributed over the entire surface area of the web, the surface density or the size of the alterations may vary from one area of the web to another. Generally speaking, the surface density of the alterations is low in the vicinity of the light source and increases as one moves farther away from the light source.

The photocatalytic particles may be applied to the various components of the fabric web in various ways.

According to a first variant, a spread coating which contains photocatalytic particles can be deposited on the binding yarns before these yarns are woven with the optical fibres. In this case the optical fibres do not have any photocatalytic particles and are used exclusively to transmit light in the vicinity of the binding yarns on which the photocatalytic particles are placed.

According to a second variant, a spread coating which contains photocatalytic particles can be deposited on the cloth formed by the optical fibres before they are associated with the binding yarns. In this case, the photocatalytic particles are embedded in the spread coating of the coated fabric web which is permeable to the gases or liquids which are to be cleaned. This spread coating can be deposited in various ways, especially by immersion, pad impregnation, as an emulsion, by spraying, printing, encapsulation or electrodeposition.

In this case, the optical fibres can be woven in places with the binding yarns, with the optical fibres being substantially positioned in a plane which is parallel to the plane defined by the binding yarns on which the spread coating is deposited. Thus, the spread coating is not deposited on the optical fibres, only on one of the sides of the web which is formed by the binding yarns. This way, the binding yarns cover the spread coating and make it possible to produce a protective screen for the optical fibres located in a parallel, offset plane.

In practice, the binding yarns can be woven as a plain wave. In fact, this type of weave gives the fabric web optimum mechanical strength and optimum surface uniformity.

According to a first embodiment, the optical fibres may comprise a core made of a material selected from a group comprising polymethyl-methacrylate (PMMA), polycarbonate (PC) and Cyclo-Olefin Polymers (COP).

In this case, the optical fibres are made of two materials and have a core clad in a sheath which can be one of several kinds.

According to a second embodiment, the optical fibres can be made of a material selected from a group comprising glass, quartz and silica. In this case, a sheath may cover the optical fibres in order to protect them or so that the photocatalytic particles can be placed on the fabric web.

Advantageously, the binding yarns can be made of a material selected from a group comprising polyamide, polyester, polyethylene and polypropylene.

In addition, the photocatalytic particles can be made of a material selected from a group comprising semiconducting substances in the form of oxides of titanium, silica, zinc, caesium, zirconium, tin and sulphides of cadmium and zinc.

The invention also relates to a complex comprising a fabric web such as that described above. Such a complex is characterised in that the fabric web is mounted on a non-woven backing capable of reflecting the light emitted by the optical fibres of the fabric web.

In other words, a non-woven fabric is used to provide a screen in order to reflect and diffuse the light emitted by the optical fibres and to deflect the light beams towards the photocatalytic particles. This way, it is possible to increase the activation efficiency of the photocatalytic particles.

In one particular embodiment, the non-woven backing of the complex may comprise a spread coating which also contains photocatalytic particles placed on at least one side of the backing facing the optical fibres of the fabric web.

This way, it is possible to position the optical fibres between the non-woven backing on the one hand and the binding yarns which are offset in a parallel plane on the other hand, with at least the side of both these elements which faces the optical fibres being covered in a spread coating which contains the photocatalytic particles.

### BRIEF DESCRIPTION OF THE DRAWINGS

In order that the way in which the invention is implemented and its resulting advantages may more readily be understood, the following description of an embodiment is given, merely by way of example, reference being made to the accompanying drawings.

FIG. 1 is a perspective view of a fabric web in accordance with the invention;

FIGS. 2 to 4 show cross-sectional views of various alternative embodiments of such a fabric web in accordance with the invention;

FIG. 5 is a cross-sectional view of a complex which incorporates a fabric web in accordance with the invention.

### DESCRIPTION OF THE PREFERRED EMBODIMENTS

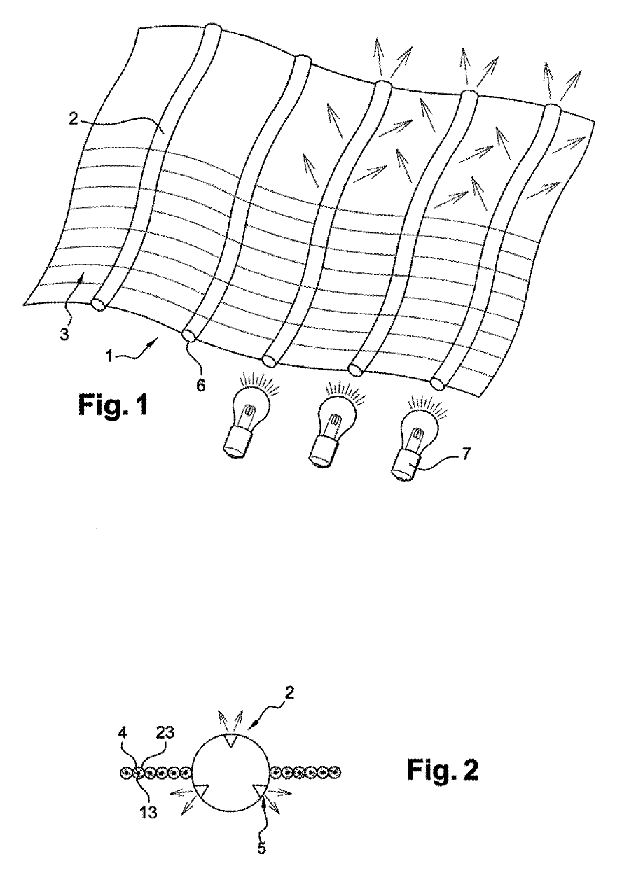

As stated above, the invention relates to a fabric web such as that shown in FIG. 1. The fabric web (1) comprises warp and/or weft optical fibres (2) woven with warp and/or weft binding yarns (3). Such a fabric web makes it possible to distribute optical fibres (2) uniformly in a plane in which they are parallel to each other. These optical fibres (2) are treated so that they transmit light and emit light sideways from their outer cylindrical surface. This treatment of optical fibres (2) produces a plurality of invasive alterations on their surface.

In addition, one or more light sources (7) is/are positioned facing the free ends (6) of optical fibres (2) which may or may not be bunched. The light emitted sideways by optical fibres (2) can be transmitted from one edge of fabric web (1) to the other at right angles to each of these edges as well as inside the fabric web.

This layout makes it possible to activate the photocatalytic particles which are placed on one of the components of the fabric web.

As shown in FIG. 2, optical fibres (2) have invasive alterations (5) which make it possible to alter the angle at which light beams are reflected inside the fibre and to transmit light sideways out of the fibre.

As shown in this Figure, photocatalytic particles (4) are added in a spread coating (23) on binding yarns (13) before these are woven with the optical fibres. The optical fibres (2) thus make it possible to route the light to binding yarns (13).

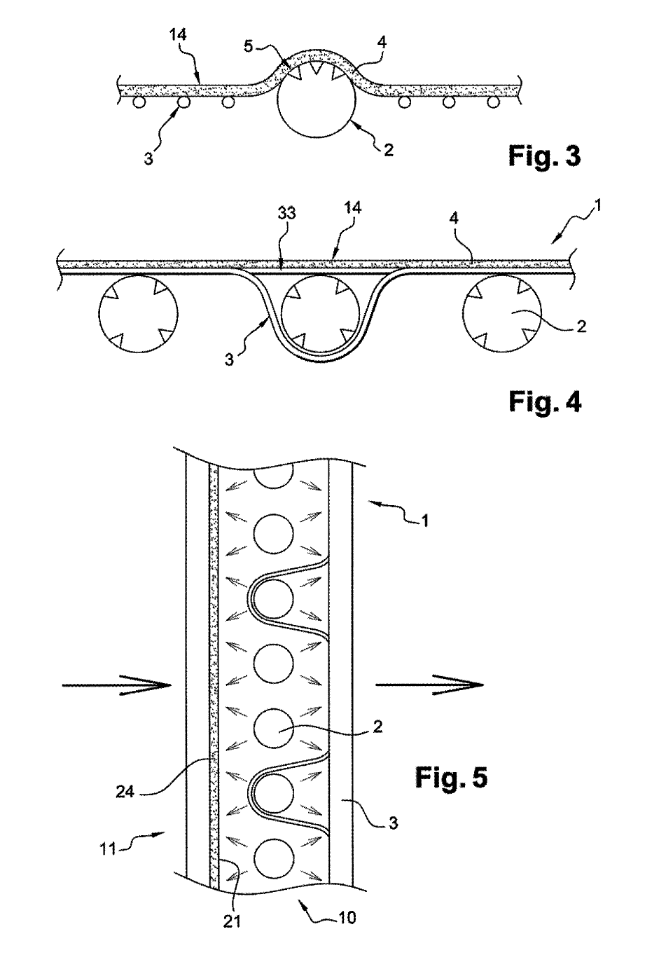

As shown in FIG. 3, photocatalytic particles (4) may also be added in a spread coating (14) which is applied to the cloth formed by optical fibres (2) which are woven with binding yarns (3). In this embodiment, the spread coating is applied to the two components of the cloth after weaving.

As shown in FIG. 4, spread coating (14) containing the photocatalytic particles (4) can be placed exclusively on binding yarns (3) if the latter are offset in a plane which is parallel to the plane defined by optical fibres (2). Optical fibres (2) are then linked in places by binding yarns (3) so as to enable an offset between ground threads (33) which incorporate the binding yarns (3) and optical fibres (2). This way, it is possible to position spread coating (14) on only one of the components of the fabric web (1) after weaving.

As shown in FIG. 5, the invention also relates to a complex (10) which has the fabric web (1) in FIG. 4 described earlier, mounted on a non-woven backing (11) which may have a spread coating (21) in which the photocatalytic particles (24) are embedded. Thus, a considerable quantity of photocatalytic particles are illuminated by optical fibres (2) and this makes it possible to significantly increase the efficiency with which pollution is removed from a fluid which flows through such a complex.

The above description makes it apparent that a fabric web in accordance with the invention has many advantages, in particular:

It makes it easy to handle and assemble photocatalytic filters thanks to the structure in which the optical fibres are linked together;

It makes it possible to reduce the number of optical fibres and hence the cost of a pollution control system;

It makes it possible to improve the efficiency with which pollution is removed from fluids which flow close or through the structure.

### INDUSTRIAL APPLICATIONS

A fabric web in accordance with the invention has many industrial applications including the following examples in particular:

Air-pollution control and pollution control for air-conditioning systems in a closed space which may accommodate large numbers of individuals such as a hospital, airport, shopping mall, train or underground station;

Air-pollution control and pollution control for air-conditioning systems in a small confined space such as an operating theatre and private or public means of transport;

Waste-water pollution control in a sewage plant basin; in water pipework and water supply systems; and

Deodorising.

The invention can also have a dual function and, as well as pollution control, can be used to provide ambient lighting or even backlighting for an advertising poster in particular.

1. A fabric web comprising warp and/or weft optical fibres woven with warp and weft binding yarns, a surface of the binding yarns being provided with photocatalytic particles, wherein said optical fibres include invasive alterations, free ends of said optical fibres can be positioned facing a light source in order to transmit light and emit the light sideways at the aforementioned alterations so as to activate said photocatalytic particles.

2. The fabric web as claimed in claim 1, wherein the invasive alterations of the optical fibres are distributed gradually over the surface area of fabric web.

3. The fabric web as claimed in claim 1, further comprising a spread coating containing the photocatalytic particles deposited on the binding yarns before they are woven with the optical fibres.

4. The fabric web as claimed in claim 1, further comprising a spread coating containing the photocatalytic particles deposited on a cloth formed by the optical fibres associated with the binding yarns.

5. The fabric web as claimed in claim 4, wherein the optical fibres can be woven in places with the binding yarns the optical fibres being substantially positioned in a plane which is parallel to the plane defined by the binding yarns on which the spread coating is deposited.

6. The fabric web as claimed in claim 1, wherein the binding yarns are woven as a plain weave.

7. The fabric web as claimed in claim 1, wherein the optical fibres comprise a core made of a material selected from a group comprising polymethyl-methacrylate (PMMA), polycarbonate (PC) and Cyclo-Olefin Polymers (COP).

8. The fabric web as claimed in claim 1, wherein the optical fibres are made of a material selected from a group comprising glass, quartz and silica.

9. The fabric web as claimed in claim 1, wherein the binding yarns are made of a material selected from a group comprising polyamide, polyester, polyethylene and polypropylene.

10. The fabric web as claimed in claim 1, wherein the photocatalytic particles are made of a material selected from a group comprising semiconducting substances in the form of oxides of titanium, silica, zinc, caesium, zirconium, tin and sulphides of cadmium and zinc.

11. A complex comprising the fabric web as claimed in claim 1, wherein the fabric web is mounted on a non-woven backing capable of reflecting the light emitted by the optical fibres of the fabric web.

12. The complex as claimed in claim 11, wherein the non-woven backing comprises a spread coating containing the photocatalytic particles placed on at least one side of the backing facing the optical fibres of the fabric web.
